(19) United States
(12) Patent Application Publication
(10) Pub. No.: US 2008/0059229 A1
(43) Pub. Date: Mar. 6, 2008

(54) PRESCRIPTION ASSISTING APPARATUS AND PRESCRIPTION ASSISTING METHOD

(75) Inventor: Satomi YAMADA, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM CORPORATION, Tokyo (JP)

(21) Appl. No.: 11/839,867

(22) Filed: Aug. 16, 2007

(30) Foreign Application Priority Data
Aug. 29, 2006 (JP) 2006-231602

(51) Int. Cl. G06Q 50/00; G06F 17/30

(52) U.S. Cl. 705/2

(57) ABSTRACT

Client terminals are installed in medical facilities, and connected through a network to a data center. Concrete cases relating to a variety of medicaments are reported at the client terminals and accumulated as case information in a medicament-to-case information database of the data center. In prescribing some medicaments, prescription data indicating the names of the medicaments is attached to inquiry data, and sent to the data center. In response to the inquiry data, a data server of the data center refers to a medicament basic information database, to check whether the medicaments indicated by the prescription data can interact adversely. If the answer is yes, the data server searches the medicament-to-case information database for such case information that relates to the interaction of these medicaments, and sends back advisory information informing of the possibility of adverse interaction of the inquired medicaments, accompanied with the retrieved case information.

### FIELD OF THE INVENTION

The present invention relates to a prescription assisting apparatus for use in prescribing medicaments for patients and a prescription assisting method using a network system for receiving inquiries about prescription content from a plurality of terminals installed in medical facilities and sending advisory information on the inquired prescription content back to the terminals.

### BACKGROUND OF THE INVENTION

In the medical facilities, the medical charts for recording medical information on individual patients are getting computerized. With this trend, a variety of electronic medical chart producers have been developed and improved in many functions. A prescription assisting function may be referred to as an exemplar of improved functions of the electronic chart producers. The prescription assisting function assists designing each prescription. For example, when data on a prescription to a patient is inputted, the electronic chart producer searches a medication database for information on caution about the prescribed content, and shows the search result.

Such a prescription assisting function helps doctors to prescribe proper medicaments even if they are not enough experienced or acquainted with medicine. Since such a medication database is too expensive for small medical facilities to own it independently, some prior arts suggest building a medical network system that enables many medical facilities to share a medication database, see for example JPA2003-271740, JPA2001-282923 and JPA2005-157570.

The prior art prescription assisting system provides information about whether prescribed medicines are compatible or not, i.e., usable in combination or not, and cautions if the prescribed medicaments can be incompatible or contraindicated for some patients. However, even such a combination of medicaments, which is attended by caution about concomitant administration, can be prescribed for some patients under some conditions. In that case, doctors are responsible to decide whether to prescribe such a combination of medicaments that might interact and cause some side-effect, using their experiences and knowledge. Therefore, in order to make a proper decision, caution about incompatibility or interaction of medicaments alone is not enough especially for inexperienced doctors. Doctors need information about practical cases, like side-effects caused by concomitant administration of medicaments, in addition to the caution about incompatibility.

Because the side-effects caused by medicament interaction vary depending upon patients, it is best to collect information about the practical cases in respective medical facilities. Furthermore, it is desirable to collect as much information about the practical cases as possible from many medical facilities. Thus, there is a great need for a medical network system that collects concrete information on the practical cases from the medical facilities, to share the collected case information as advisories and cautions between the medical facilities.

### SUMMARY OF THE INVENTION

In view of the foregoing, a primary object of the present invention is to provide a prescription assisting apparatus and a prescription assisting method, which permits providing concrete advisory information on medicaments helpful for designing an adequate prescription.

The present invention suggests a prescription assisting apparatus that is connected through a network to a plurality of terminals installed in medical facilities, so as to receive inquiries about prescription content from the terminals and send advisory information on the inquired prescription content back to the terminals, wherein the prescription assisting apparatus comprises:

a basic information database storing basic information on medicaments; an advisory information searching device that checks the inquired prescription content with the basic information to retrieve the advisory information; a device for receiving case information from the terminals, each of the case information informing of concrete effects of prescribed medicaments reported about a patient who took the prescribed medicaments; a case information database for registering and accumulating the received case information; a case information searching device for searching the case information database to retrieve such case information that relate to the inquired prescription content; and a device for sending the retrieved advisory information accompanied with the related case information back to the terminal from which the inquiry has been sent.

The basic information preferably include information on interaction between the medicaments, and the advisory information searching device includes a device for checking whether the inquired prescription content is adequate in view of the interaction. The information on the interaction preferably include information on incompatibility and cautions about concomitant administration of the medicaments.

When the retrieved advisory information indicates that the inquired prescription content includes a combination of medicaments that need caution about concomitant administration, the case information searching device searches for such case information that relate to the interaction between these medicaments.

If the inquiry from the terminal information includes information on attributes of the patient, the case information searching device adds to the attribute information to search criteria to retrieve the case information from a restricted range of the case information database.

A prescription assisting method of the present invention comprises steps of:

storing basic information on medicaments in a basic information database;

checking the inquired prescription content with the basic information to retrieve the advisory information;

receiving case information from the terminals, each of the case information informing of concrete effects of prescribed medicaments reported about a patient who took the prescribed medicaments;

registering and accumulating the received case information in a case information database;

searching the case information database for such case information that relate to the inquired prescription content; and

sending the retrieved advisory information accompanied with the related case information back to the terminal from which the inquiry has been sent.

Thus, a plurality of the case information informing of concrete effects of prescribed medicaments on patients who took the prescribed medicaments are reported by the medical facilities, and accumulated in the case information database. In response to each inquiry, such case information as well as advisory information that relate to the inquired prescription content are searched for, and the retrieved advisory information accompanied with the related case information are sent back to the terminal, from which the inquiry has been sent. Therefore, the doctor can decide on the prescription while taking the concrete case information about the medicaments into consideration.

According to the preferred embodiment, the adequacy of the prescribed content is checked in view of the interaction between the prescribed medicaments, and the case information relating to the interaction is retrieved. So it assists the doctor to design the prescription more adequately.

### BRIEF DESCRIPTION OF THE DRAWINGS

The above and other objects and advantages of the present invention will be more apparent from the following detailed description of the preferred embodiments when read in connection with the accompanied drawings, wherein like reference numerals designate like or corresponding parts throughout the several views, and wherein:

FIG. 1 is a schematic diagram illustrating a schematic structure of a medical network system;

FIG. 2 is a block diagram illustrating a schematic structure of a client terminal of the medical network system;

FIG. 3 is a block diagram illustrating a schematic structure of a data center of the medical network system;

FIG. 4 is an explanatory diagram illustrating a medicament-to-case information database of the data center;

FIG. 5 is an explanatory diagram illustrating an example of a dialog box displaying a patient check-in list;

FIG. 6 is an explanatory diagram illustrating an example of a warning dialog box displayed when any case information relating to a previous prescription has not been registered;

FIG. 7 is an explanatory diagram illustrating an example of a case reporting dialog box for inputting case reporting data;

FIG. 8 is an explanatory diagram illustrating an example of a dialog box indicating an electronic medical chart;

FIG. 9 is an explanatory diagram illustrating an example of a dialog box for inputting content of a prescription;

FIG. 10 is an explanatory diagram illustrating an example of a caution dialog box displayed when caution is advised on concomitant administration of prescribed medicaments;

FIG. 11 is an explanatory diagram illustrating an example of a dialog box displaying case information;

FIG. 12 is an explanatory diagram illustrating an example of the dialog box indicating the electronic medical chart displayed when such a combination of medicaments are prescribed that must be administrated with caution;

FIG. 13 is a flowchart illustrating a procedure of revising the electronic medical chart;

FIG. 14 is a flowchart illustrating a sequence of processes searching for case information, executed through data communication between the client terminal and the data center;

FIG. 15 is a flowchart illustrating a sequence of processes for registering case information; and

FIG. 16 is an explanatory diagram illustrating an example of a dialog box for designating which one of a plurality of case information should be displayed.

### DESCRIPTION OF THE PREFERRED EMBODIMENTS

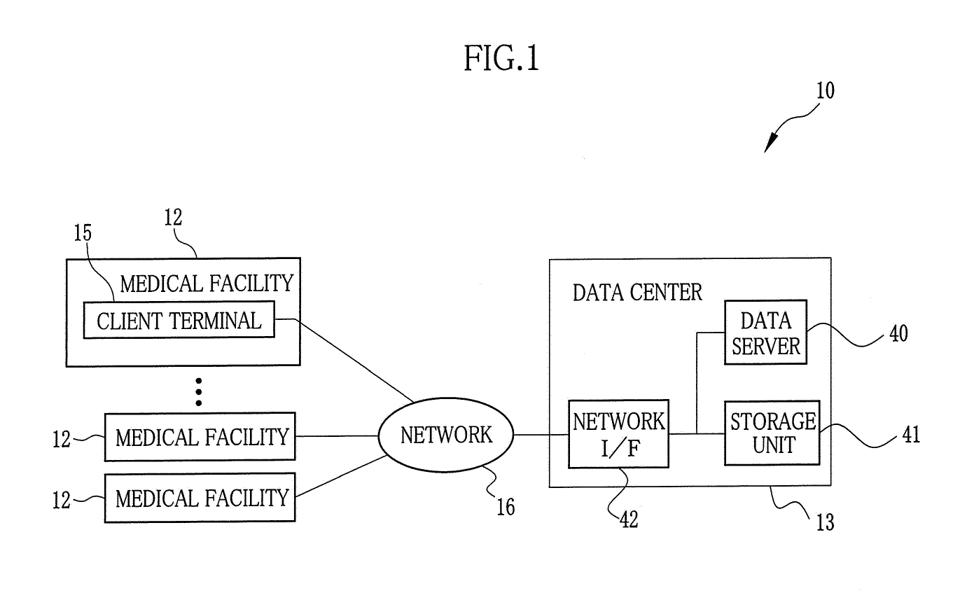

FIG. 1 shows a structure of a medical network system 10. The medical network system 10 is constituted of a plurality of medical facilities 12, such as hospitals and clinics, and a data center 13 connected to the respective medical facilities 12. Concretely, client terminals 15 of the respective medical facilities 12 are connected through a network 16 to a data server 40 of the data center 13, to communicate medical data between them. The client terminal 15 is producing an electronic medical chart MSI, which puts medical information on an individual patient together into a data file. Hereinafter, the data file of the electronic medical chart MSI will be called the MSI file. In the present embodiment, each data file includes patient data obtained at reception, diagnostic data obtained through consultation, examination and inspection, and prescription data indicating medications prescribed based on the diagnosis data. In each MSI file, the diagnosis data and the prescription data are arranged time sequentially. Note that the client terminals 15 may be connected through a local area network (LAN) or the like to modalities, i.e. imaging machines for medical application, and printers.

The MSI file also contains registration record data that indicates records of registration of case information CI, wherein the case information CI informs of practical cases relating to side-effects of prescribed medicaments, countermeasures to the side-effects and the like. In the present embodiment, the registration record data consists of revision data that indicates whether the content of prescription has been revised, and recording data that indicates whether the case information IC has been registered in relation to the revised prescription.

The patient data represent information on the attributes of the patient, such as patient's name, patient's ID, patient's address, birthday, age and sex, and medical history and allergies of the patient and family members. The patient's ID is a number specific to each individual patient, which is automatically issued from the client terminal 15 when the patient data is newly inputted. For example, the patient's ID consists of eight figures, wherein first four figures represent a medical facility number specific to each individual medical facility, and last four figures represent a serial number allocated to each patient. Thus, any medical facility will not issue an identical patient's ID to other medical facilities'. The patient's ID is not limited to a numerical code but may be a code consisting of figures, letters, characters and signs. Note that the patient data may be inputted through a not-shown receipt computer instead of the client terminal 15, the receipt computer being used for producing and recording receipts.

The diagnostic data consists of information on medical examination including the date of consultation, the medical department in charge of the patient, the results of diagnosis, duration of therapy, and information on inspection including medical images captured from the patient, symptoms and indications found by the inspection, the date of inspection, the machine used for inspection, an applied inspection method and inspected body sites. The information on applied inspection method includes the imaging directions to the patient, such as front imaging and side imaging, and whether a contrast agent is used or not. The body sites may be chest, trunk, limbs, lumber vertebrae or other body regions. The prescription data includes names of prescribed medications and their administration amount.

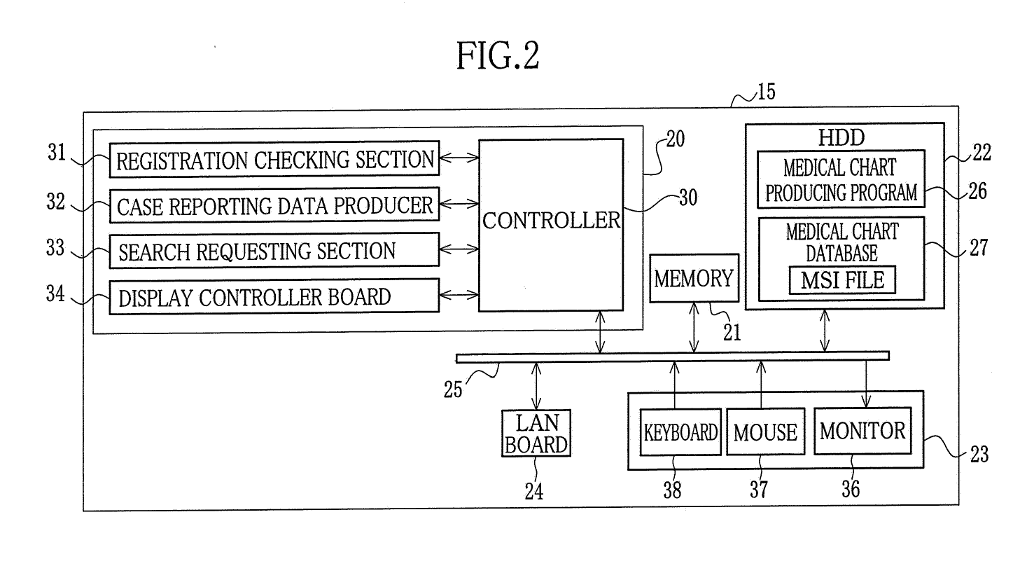

As shown in FIG. 2, the client terminal 15 may be a well-known personal computer or workstation that is provided with a CPU 20, a memory 21, a hard disc drive (HDD) 22, a console 23 and a LAN board 24, which are connected to each other through a bus 25. The CPU 20 reads out a medical chart producing program 26 from the HDD 22, to function as a registration checking section 31, a case reporting data producer 32, a search requesting section 33 and a display controller 34. The controller 30 totally controls the respective functions of these sections 31 to 34 according to the medical chart producing program 26.

The console 23 consists of a monitor 36, a mouse 37 and a keyboard 38. The monitor 36 may be a well-known liquid crystal display or CRT display.

The registration checking section 31 refers to the registration record data when the MSI file is read out from a medical chart database 27 that is stored in the HDD 22, and checks whether the content of prescription has been revised. If the registration record data shows that the content of prescription has been revised, the registration checking section 31 checks whether any case information CI relating to the revised content of prescription has been registered. If the content of prescription has been revised but no case information CI relating to the revised content of prescription is registered, a warning is displayed on the monitor 36, to require registration of appropriate case information CI, as set forth in detail later.

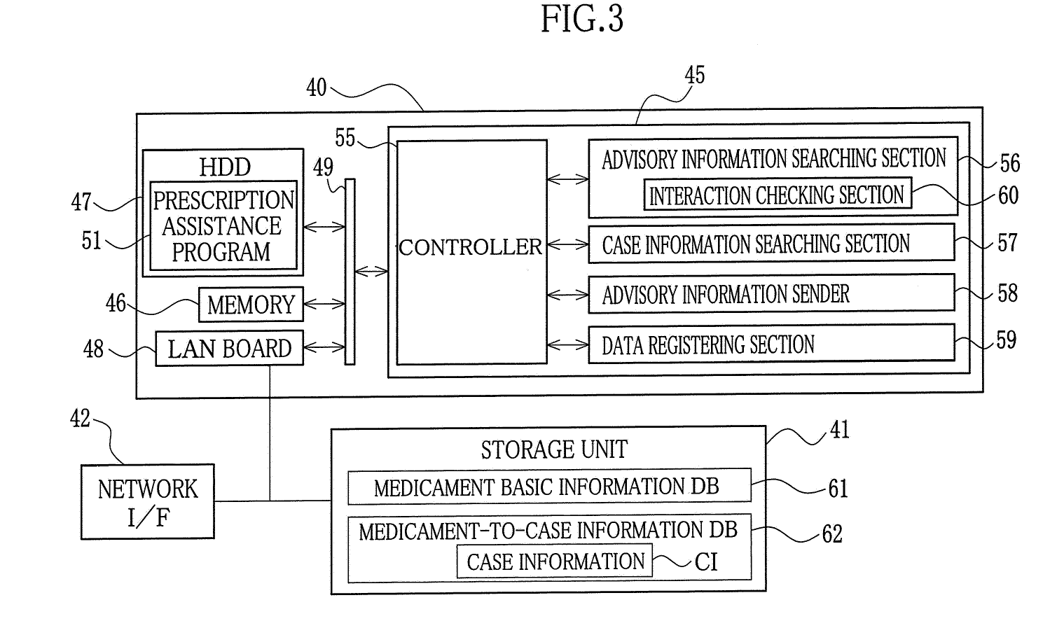

The case reporting data producer 32 produces data to be registered as new case information CI in the data center 13, hereinafter referred to as case reporting data, from information on each practical case inputted through the client terminal 15. The case reporting data or case information consists, for example, of attribute information on the patient, names of prescribed medicaments, information on side-effect caused by concomitant administration of these medicaments, information on the course after the administration, information on countermeasure and the like. The case reporting data producer 32 produces and sends the case reporting data to the data center 13. As the data center 13 sends back a registration complete signal, which indicates that the case reporting data from the client terminal 15 has been registered as new case information CI in a medicament-to-case information database 62 of the data center 13, see FIG. 3, so the case reporting data producer 32 adds the record of registration of the case information CI to the registration record data that is attached to the MSI file. The registration complete signal consists, for example, of date and time of registration and registration number. On the other hand, in a case where the prescription data is newly produced in the MSI file, the case reporting data producer 32 attaches the registration record data to the electronic medical chart of the MSI file.

The search requesting section 33 sends inquiry data to the data center 13, requesting searching for information on caution about the content of prescription indicated by the prescription data and the case information CI relating to the caution, i.e. practical cases relating to side-effects caused by concomitant administration of the prescribed medicaments. Before sending the inquiry data to the data center 13, the search requesting section 33 attaches the prescription data and the medical facility number and other necessary information to the inquiry data.

The display controller 34 controls displaying a variety of screens on the monitor 36, which are necessary for producing the MSI file. The display controller 34 also controls displaying the warning for requiring registration of the case information CI and registration screens necessary for registering the case information CI.

The HDD 22 stores the above-mentioned medical chart producing program 26 and medical chart database 27 that stores the produced MSI files. The HDD 22 also stores advisory information and adequacy information, which are obtained from the data center 13, as set forth in detail later.

The data center 13 functions as a prescription assisting device. The data center 13 is provided with the data server 40, a storage unit 41 and a network interface 42 for connection to the network 16, which are connected to each other through a LAN inside the data center 13.

As shown in detail in FIG. 3, the data server 40 is provided with a CPU 45, a memory 46, an HDD 47 and a LAN board 48, which are connected to each other through a bus 49. The CPU 45 reads a prescription assistance program 51 from the HDD 47, to control the data center 13. The memory 46 is used to develop the prescription assistance program 51. The HDD 47 memorizes the prescription assistance program 51 and also stores the inquiry data and the register data temporarily when these data are sent from the client terminal 15.

After reading out the prescription assistance program 51, the CPU 45 functions as a controller 55, an advisory information searching section 56, a case information searching section 57, an advisory information sender 58 and a case reporting data receiver 59. The controller 55 totally controls the respective functions activated according to the prescription assistance program 51.

The advisory information searching section 56 is activated when the inquiry data is sent from the client terminal 15 to the data center 13. The advisory information searching section 56 reads the names of the prescribed medicaments from the prescription data attached to the inquiry data, and refers the names of the prescribed medicaments to a medicament basic information database 61, to retrieve any advisory information about the medicaments indicated by the prescription data. For example, the advisory information searching section 56 is provided with an interaction checking section 60 that checks whether the prescribed medicaments indicated by the prescription data can interact adversely if used in combination. That is, the advisory information includes such information that indicates those medicaments which should be administrated with caution about combined usage, i.e. about interaction with other medicaments, as well as incompatible medicaments which should not be administrated concomitantly.

When the interaction checking section 60 retrieves such advisory information that the prescribed medicaments can adversely interact with each other, the case information searching section 57 refers to the medicament-to-case information database 62 of the storage unit 41, to retrieve such case information CI that relates to the prescribed combination of medicaments. If the interaction checking section 60 retrieves such advisory information that the prescribed medicaments are incompatible, the case information searching section 57 retrieves such case information CI that relates to the incompatible medicaments.

The advisory information sender 58 sends the advisory information to the client terminal 15 when the advisory information is retrieved from the medicament basic information database 61 in response to the inquiry data. At that time, if the case information CI relating to the retrieved advisory information is retrieved from the medicament-to-case information database 62, the advisory information sender 58 attaches the retrieved case information CI to the related advisory information, and send them to the client terminal 15. If, on the other hand, the advisory information searching section 56 does not retrieve any advisory information, the advisory information searching section 56 sends the client terminal 15 the adequacy information that indicates that no caution is advised. The case reporting data receiver 59 receives the case reporting data from the client terminal 15, and writes it as new case information CI in the medicament-to-case information database 62 of the storage unit 41.

The storage unit 41 is a so-called network-type storage device. The storage unit 41 is constituted of media drivers for a variety of recording media, like DVD, and HDD. It is possible to install a number of storage units, for example, a main storage unit and a backup storage unit. The storage unit 41 may also be an assembly of a number of drives provided for storing case information CI in groups of some classification. The storage unit 41 is not limited to the network-type, but may be the HDD of the data server.

In the illustrated embodiment, the medicament basic information database 61 and the medicament-to-case information database 62 are separately built in the storage unit 41, but these databases may be integrated into a single database. The medicament basic information database 61 stores the medicament information on individual medicaments. For example, the medicament information includes information disclosed by pharmaceutical companies and public institutions, and information obtained from literatures on researches. In detail, the medicament information includes basic information such as potencies and effects of the individual medicaments and how to and how much the medicaments should be administrated, information on caution about concomitant administration, consisting of medicament names that need caution about concomitant administration, adverse effects of these medicaments when used in combination, countermeasures and treatment to the adverse effect, and information on incompatibility, consisting of medicament names that are incompatible, adverse effects of the concomitant administration of the incompatible medicaments, and countermeasures and treatment to the adverse effects. The medicament information further includes information on side-effect, information on other cautions about usage of the medicaments. Since every medicament is numbered with a classification ID of six figures, the medicament information may be classified and managed according the ID numbers in the medicament basic information database 61.

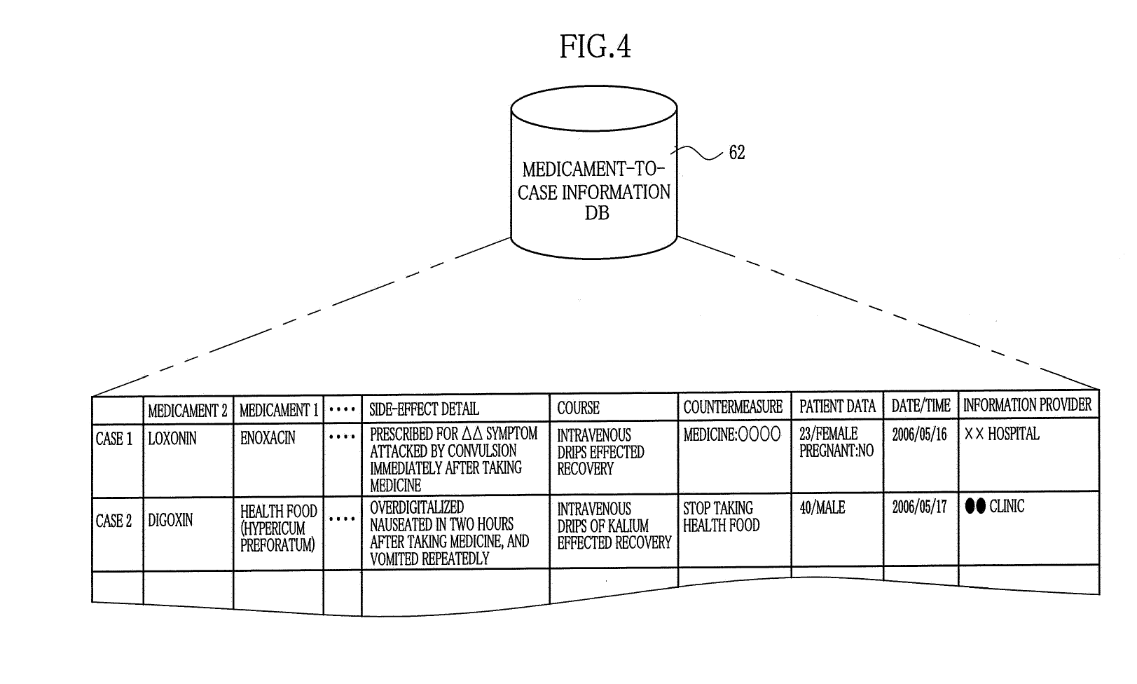

As shown in FIG. 4, the medicament-to-case information database 62 stores the case information CI relating to many medicaments. The case information CI informs of practical cases, such as side-effects of respective medicaments and interaction of the respective medicaments. In the illustrated embodiment, each case information CI consists of the name (s) of medicament (s) administrated to a patient, the side-effect on the patient, the course after the administration, the countermeasure to the patient, and attribute information on the patient. For example, in a case where loxonin tablets and enoxacin are prescribed, these medicament names are memorized, and such comment on their side-effect as cited in FIG. 4 is memorized as comment data. Furthermore, such comment data as cited in FIG. 4, i.e. “intravenous drips effected recovery”, is memorized as information on the course after administration, and also the name of a medicament used as the countermeasure is memorized.

The network interface 42 converts data to a format adaptable to the LAN of the data center 13 and a format adaptable to the network, so as to connect the LAN of the data center 13 and the network to each other. The network interface 42 may be constituted of a modem or a rooter that is selected according to the standards of the network and the LAN.

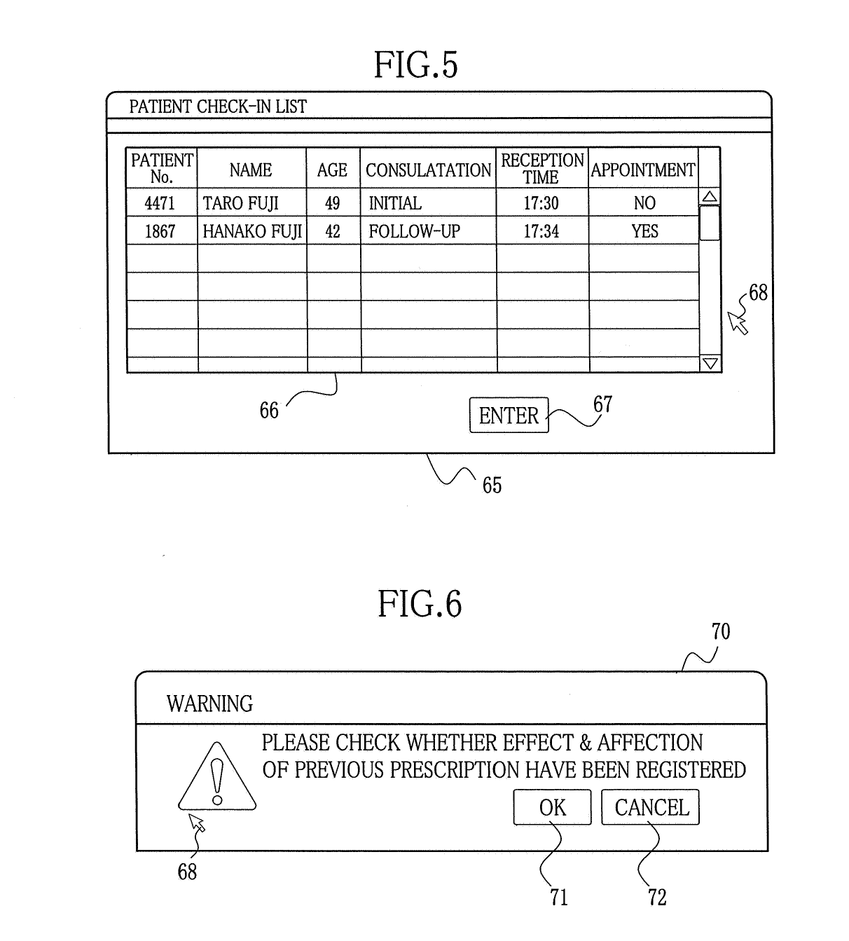

Now the monitor screens for producing and revising the MSI file on the client terminal 15 will be described. FIG. 5 is an example of a dialog box 65 displayed on the monitor 36. The dialog box 65 is provided with a patient list 66 indicating patients who have checked in at a reception desk of a medical facility. The patient list 66 shows respective ID numbers of the patients who have checked in, their names, sexes and ages, first consultation or follow-up, their reception times, appointment and so on. On the patient list 66, the operator of the client terminal 15, a doctor or a nurse, designates a patient who is coming in, and presses an enter button 67. Note that any button displayed on the monitor 36 may be pressed by clicking the mouse 37 while locating a pointer 68 on the button.

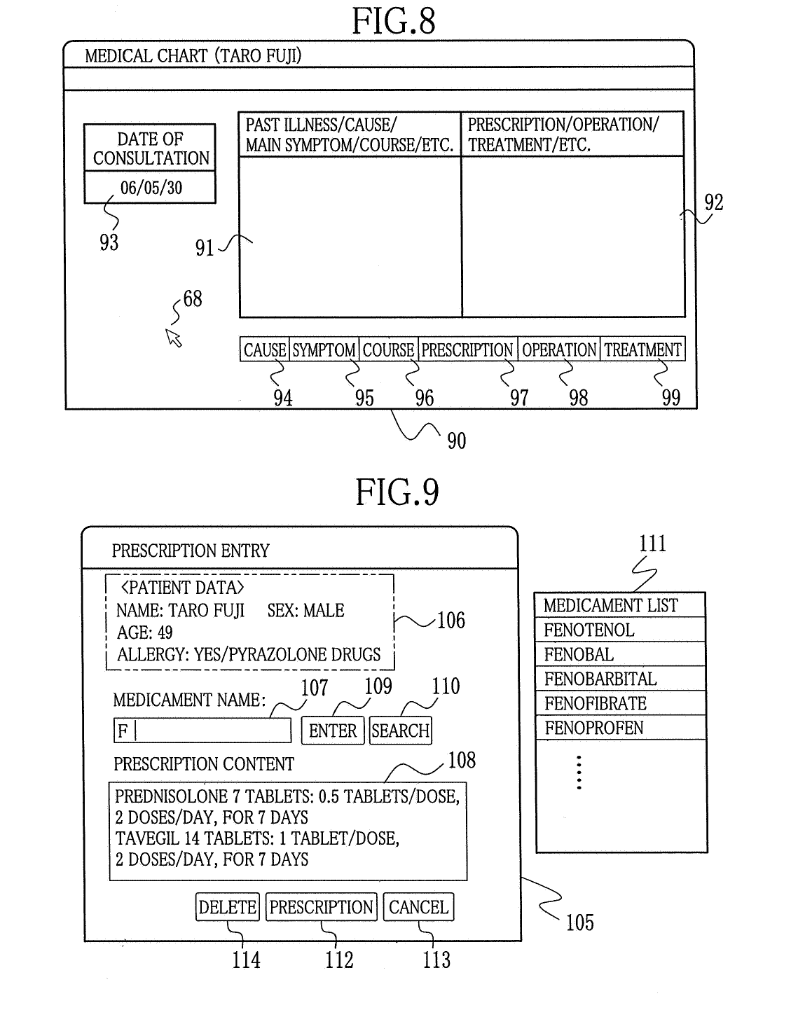

Upon the enter button 67 being pressed, the MSI file containing data of a medical chart of the designated patient is read out from the medical chart database 27, and the registration checking section 31 refers to the registration record data and checks whether the content of prescription has been revised. If so, the registration checking section 31 checks whether any case information CI relating to the revised content of prescription has been registered. If the content of prescription is not revised or the content of prescription is revised but some case information CI relating to the revised content of prescription has been registered, the monitor 36 displays a dialog box 90 as an electronic medical chart of the designated patient, as shown for example in FIG. 8. If the content of prescription is revised but any case information CI relating to the revised content of prescription has not been registered, the monitor 36 displays a warning.

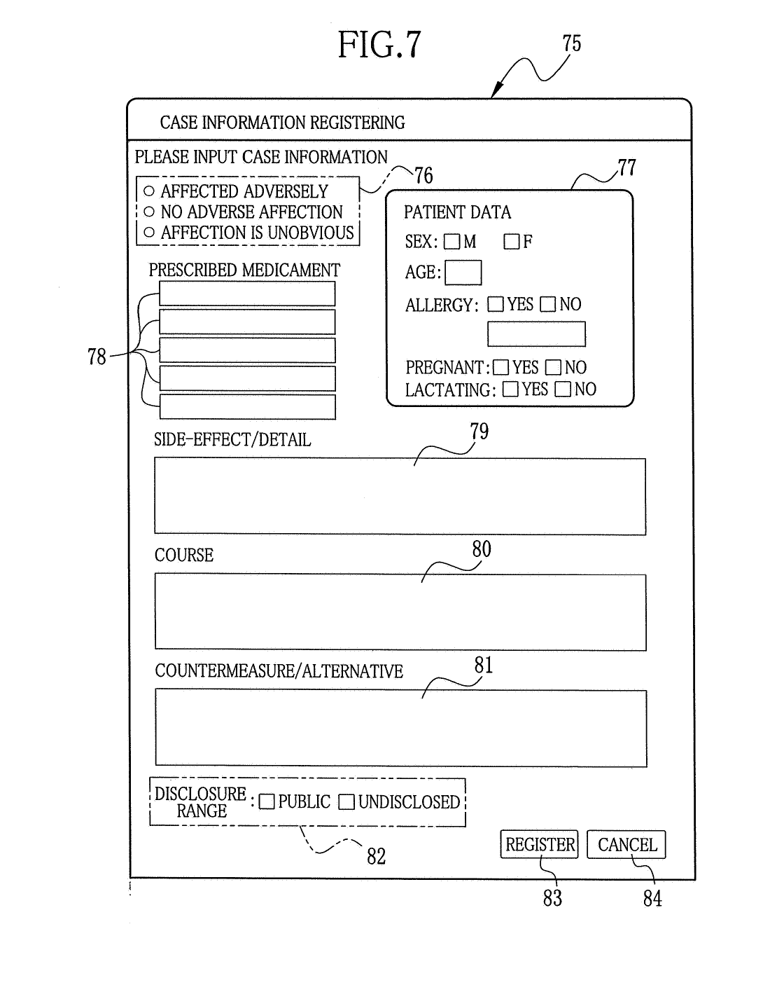

FIG. 6 shows an example of a warning dialog box 70 displayed when any case information CI relating to the revised content of prescription has not been registered. The warning dialog box 70 is provided with a warning “Please check whether effect and affection of previous prescription have been registered”, an OK button 71 and a cancel button 72. When the OK button 71 is pressed, the warning dialog box 70 disappears and a case information registering dialog box 75 is displayed, as shown for example in FIG. 7, for inputting data to be registered as the case information, i.e. the case reporting data. On the other hand, if the cancel button 72 is pressed, the process for inputting the case recording data is canceled.

As shown in FIG. 7, the case information registering dialog box 75 is provided with a choice column 76 questioning any adverse affection of the prescribed medicaments, a display column 77 displaying information on the designated patient, an entry column 78 for inputting names of prescribed medicaments, an entry column 79 for inputting side-effects and details, an entry column 80 for inputting the course after the administration, an entry column 81 for inputting countermeasures or alternatives, and an entry column 82 for selecting the range of disclosure of the present case reporting data after it is registered as the case information CI. There are also a register button 83 and a cancel button 84. The register button 83 is pressed to enter the inputted information as the case reporting data. The cancel button 84 is pressed to cancel registering the inputted information.

As shown in FIG. 8, the dialog box 90 presenting the electronic medical chart is provided with a comment column 91 for displaying or writing comments on past illnesses, causes, main indications and course, a comment column 92 for displaying or writing comments on prescription, operation and treatment, and a display column 93 for displaying the date of consultation. Pressing a cause button 94, a symptom button 95 or a course button 96 enables writing comments in the comment column 91. Pressing a prescription button 97, an operation button 98 or a treatment button 99 enables writing comments in the comment column 92. If it is determined that the prescribed medicaments need caution about concomitant administration, comments on points to pay attention are automatically written in the comment column 92. But in that case, the comments may also be manually written in the column 92. By designating the date of consultation in the display column 93, comments written on the designated date are displayed in the comment columns 91 and 92.

FIG. 9 shows an example of a prescription entry dialog box 105 for inputting the content of prescription. The prescription entry dialog box 105 is displayed when the prescription button 97 is pressed on the dialog box 90. The prescription entry dialog box 105 is provided with a display column 106 for displaying attribute information on the patient, a medicament name entry column 107 for inputting a medicament name to prescribe, a prescription content display column 108 for displaying the inputted names of medicaments. For example, when an enter button 109 is pressed after a medicament name is written in the medicament entry column 107, the inputted medicament name is registered as a prescribed medicament, and displayed in the prescription content display column 108.

When a search button 110 is pressed after an initial letter of a candidate medicament name is written in the medicament entry column 107, a medicament list 111 is popped up, and so the operator can choose the expected medicament name from among the list 111. When one of the medicament names is chosen on the list 111, the chosen medicament name is registered as a prescribed medicament and displayed in the prescription content display column 108. The operator can input the administration amount of each medicament in the prescription content display column 108. For example, the administration amount indicates the amount of dosage and how many doses a day. When the operator presses a prescription button 112 after entering the administration amount, the prescription data is produced based on the entered medicament names, and is attached to the inquiry data, to be sent to the data center 13. A cancel button 113 is for canceling the prescription, whereas a delete button 114 is for deleting a medicament name from the prescription content display column 108. That is, when the delete button 114 is pressed while one of the medicament names is chosen in the prescription content display column 108, the chosen medicament name is deleted.

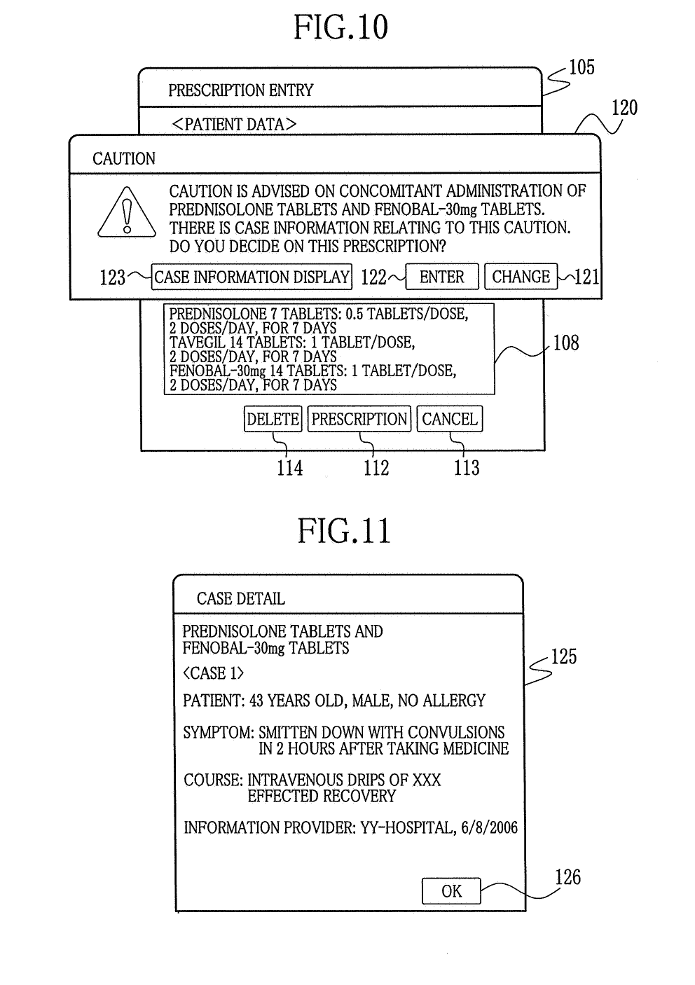

FIG. 10 shows an example of a caution dialog box 120 displayed when the advisory information, which is obtained from the data center 13 on the basis of the prescription data, indicates a caution that some of the prescribed medicaments can interact adversely when used in combination. In the illustrated example, the caution dialog box 120 displays a comment “Caution is advised on using prednisolone tablets and fenobal-30 mg tablets in combination”.

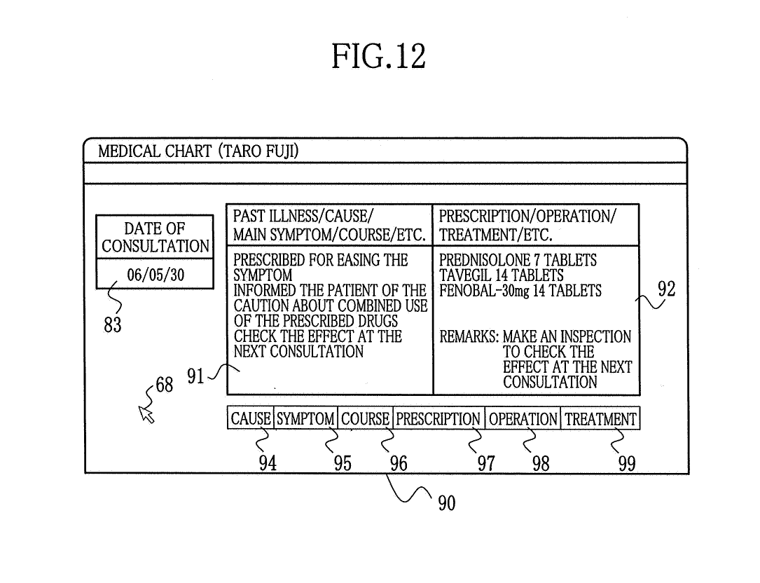

The caution dialog box 120 is also provided with a change button 121, an enter button 122 and a case information display button 123. The change button 121 is pressed to change any of the prescribed medicaments. When the change button 121 is pressed, the caution dialog box 120 disappears, and the prescription entry dialog box 105 appears for inputting the name of an alternative medicament. The enter button 122 is pressed to decide on the content inputted in the prescription entry box 106. When the enter button 122 is pressed, the dialog box 90 presenting the electronic medical chart appears again, but with the content of prescription displayed in the comment column 92, as shown for example in FIG. 12. Beside the content of prescription, remarks or reminders for the next consultation are displayed. Simultaneously with this, the registration record data is added to the MSI file. The case information display button 123 is pressed to display the case information CI that informs of practical cases of side-effects caused by the concomitant administration of the prescribed medicaments, about which the caution has been displayed. When the case information display button 123 is pressed, a dialog box 125 displaying the case information CI appears on the monitor 36, as shown for example in FIG. 11.

As shown in FIG. 11, the dialog box 125 displays information on a case patient, such as the age and sex of the patient, and whether the patient has some allergy, as well as symptoms caused by the administration and treatments or procedures against the symptoms. If there are many cases relating to the same medicament, all case information CI may be displayed in respective dialog boxes, or may be displayed one by one in a single dialog box. When an OK button 126 is pressed, the dialog box 125 displaying the case information CI disappears.

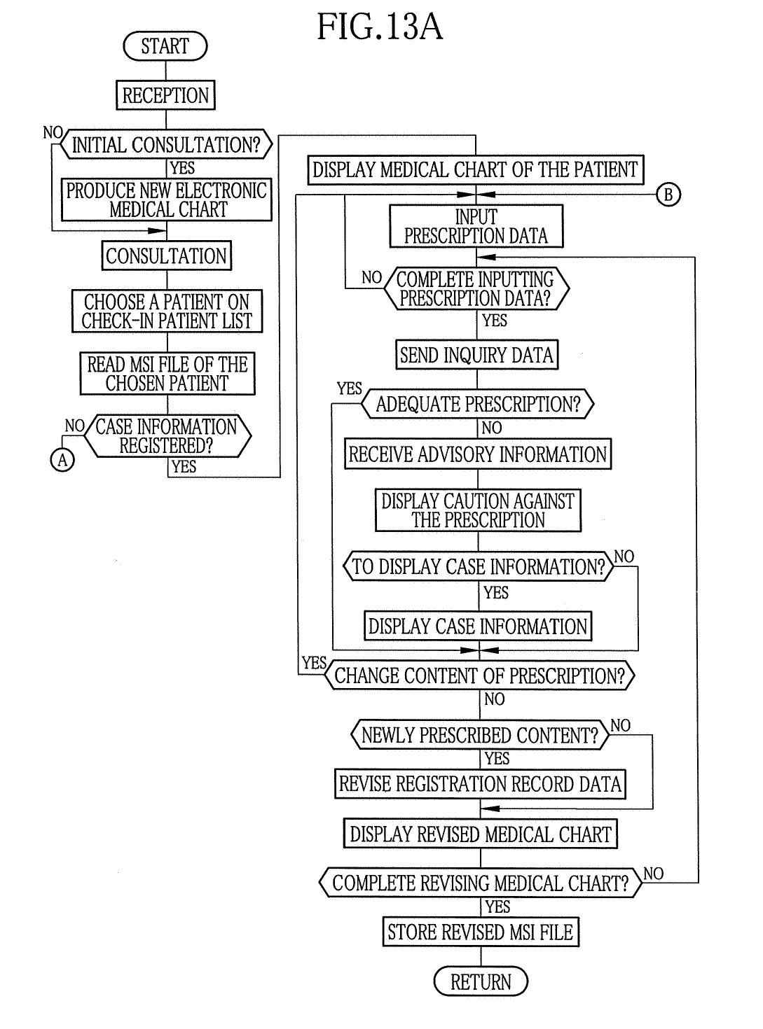

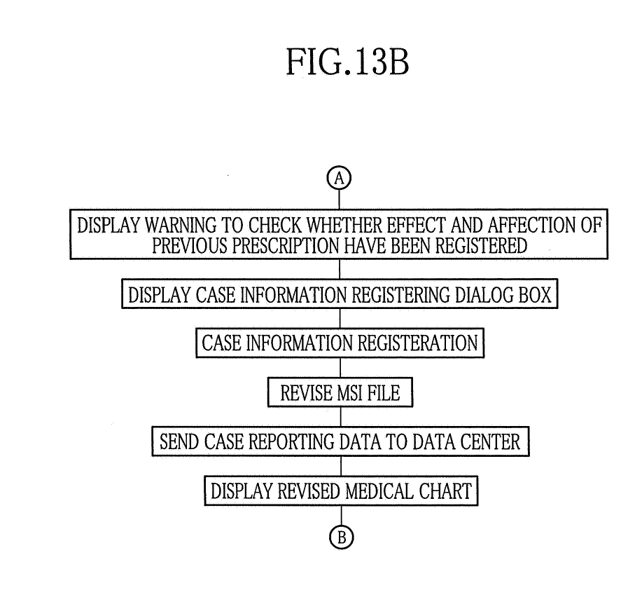

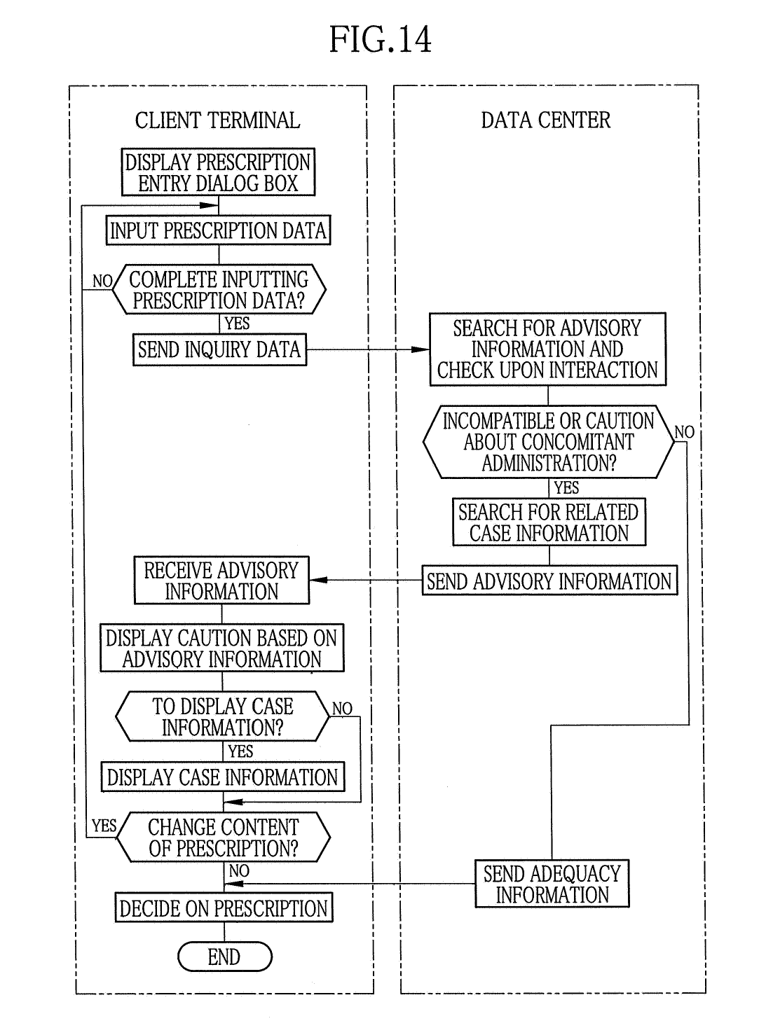

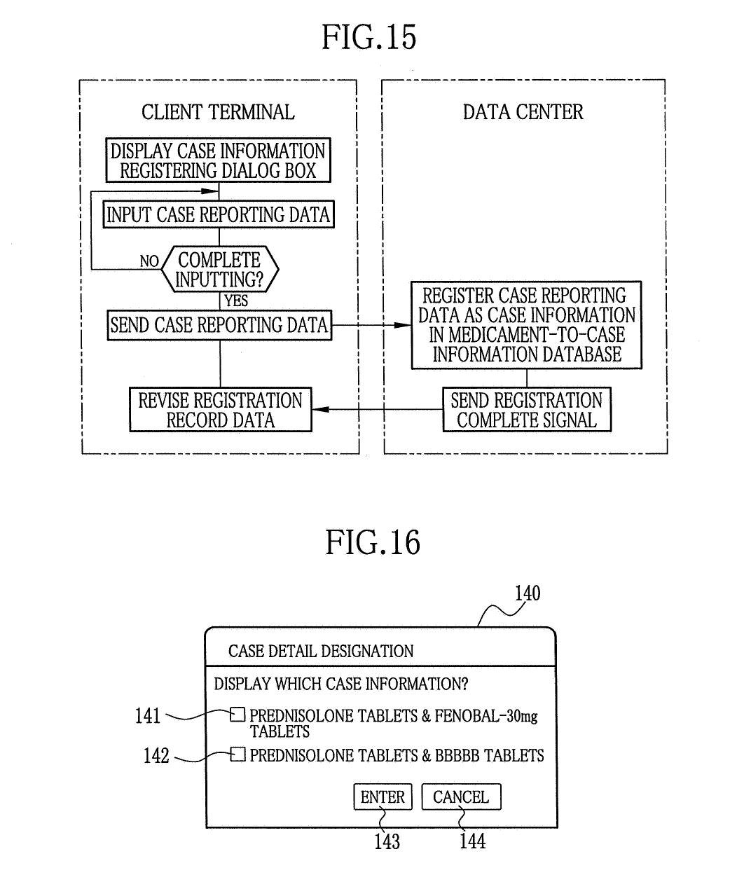

Now the procedure of producing and revising the electronic medical chart will be described with reference to the flowcharts shown in FIGS. 13 to 15.

As a patient comes to a medical facility 12 for the first time, attribute information on the patient is registered in the client terminal 15 at the reception, to produce a new MSI file of the medical chart information on the patient. The MSI file is stored in the HDD 22. Thus, from the next visit to the medical facility 12, the stored MSI file is read out from the HDD 22, so it is unnecessary to produce a new MSI file for the patient who has ever taken some consultation at the medical facility 12.

From the patient list 66 displayed on the monitor 36 of the client terminal 15, which is installed in an examination room, a doctor selected the name of a patient who is coming to see the doctor. Then, the MSI file of the selected patient is read out from the medical chart database 27 of the HDD 22. Simultaneously, the registration record data attached to the read MSI file is checked to determine whether any case information CI is registered. Because the new MSI file, which is produced for the patient at the initial consultation, contains no prescription data or record of revision of the prescription content, the dialog box 90, as shown in FIG. 8, is displayed as the medical chart on the monitor 36 when the new MSI file is read out. Also when the registration record data shows that some case information CI has been registered at the previous consultation, the dialog box 90 is displayed on the monitor 36.

The doctor inputs necessary information, such as symptoms of the patient, through the keyboard 38 of the client terminal 15, while counseling the patient. After the patient is diagnosed by inspections and other procedures, the doctor writes comments in the respective comment columns 91 and 92 of the dialog box 90, operating the mouse 37 and the keyboard 38. For example, when the doctor will write a prescription, the doctor presses the prescription button 97. Then, the prescription entry dialog box 105 for inputting medicament names is displayed on the monitor 36, as shown in FIG. 9.

According to the symptoms of the patient, the doctor prescribes medicaments by writing the medicament name directly in the entry column 107, or by selecting the medicament name from the medicament list 111. As a result, a list of prescribed medicaments is displayed in the prescription content display column 108. In association with the medicament name, the amount of administration of the prescribed medicament is inputted in the column 108. If the doctor inputs a wrong medicament name in the prescription content display column 108, the doctor can delete the wrong name from the column 108 by pressing the delete button 114.

When the names and administrating amounts of the medicaments have been written in the prescription content column 108 and thus registered as the prescription data, the doctor presses the prescription button 112 in the prescription entry dialog box 105. Then, the CPU 20 attaches the prescription data to the inquiry data, and sends them to the data center 13. Note that the medical facility number is also attached to the inquiry data.

The inquiry data sent from the client terminal 15 is received on the data server 40 of the data center 13. The data server 40 reads the medicament names from the prescription data as attached to the inquiry data, and searches the medicament basic information database 61 of the storage unit 41 for advisory information relating to the prescribed medicaments. Specifically, the interaction checking section 60 of the advisory information searching section 56 checks the medicament information stored in the medicament basic information database 61, to check whether the medicaments indicated by the prescription data can interact adversely and therefore must be administrated with caution about combined usage, or whether they are incompatible or not.

If there is no advisory information relating to the prescribed medicaments, the advisory information sender 58 sends the adequacy information back to the client terminal 15, notifying that no caution is advised. Then, the prescription entry dialog box 105 disappears and the dialog box 90 appears again, but the prescribed content is displayed in the comment column 92 of the dialog box 90. If, on the other hand, the interaction checking section 60 determines that the prescribed medicaments can adversely interact with each other, the case information searching section 57 is activated. The case information searching section 57 refers to the medicament-to-case information database 62 of the storage unit 41, to retrieve such case information CI that relates to the prescribed combination of medicaments. Then, the advisory information sender 58 attaches the retrieved case information CI to the advisory information relating to the prescribed content, and sends them back to the client terminal 15.

When the advisory information is sent back to the client terminal 15, the CPU 20 of the client terminal 15 reads out the advisory information and drives the monitor 36 to display a warning. For example, where prednisolone tablets, tavegil tablets and fenobal-30 mg tablets are registered as the prescription content, an advisory “Caution is advised on using prednisolone tablets and fenobal-30 mg tablets in combination” is displayed in the caution dialog box 120, as shown in FIG. 10. If the doctor wants to see the case information CI attached to the advisory information, the doctor presses the case information display button 123 of the caution dialog box 120. Then, the dialog box 125 containing the case information CI is displayed on the monitor 36, as shown in FIG. 11.

If the doctor decides to change the content of prescription after checking the case information CI on the dialog box 125, the doctor presses the change button 121 of the caution dialog box 120. Then, the caution dialog box 120 disappears and the prescription entry dialog box 105 appears. So the doctor chooses such a medicament name in the prescription content display column 108 that is to be changed, and presses the delete button 114. For example, when fenobal-30 mg tablets are to be replaced by another medicament, the delete button 114 is pressed while the fenobal-30 mg is chosen in the prescription content display column 108. Then the fenobal-30 mg is deleted from the prescription content display column 108 and thus from the prescription. Thereafter, another medicament name is registered by inputting the name in the medicament entry column 107 and pressing the decide button 109. Thereafter when the prescription button 112 is pressed, the inquiry data accompanied with the revised prescription data is sent to the data server 40 for searching any related advisory information.

When the prescription of the medicaments is decided, the decided medicaments are automatically written in the comment column 92 of the dialog box 90, as shown in FIG. 12. In this way, the doctor can get information on the medicaments before prescribing them to the patient, including side-effects of the medicaments reported in practical cases. So the doctor can write a prescription more properly to the individual patient. Even if the prescribed content is judged to be inadequate, that is, if the advisory information is sent back from the data center 13, the doctor can decide not to change the prescription by pressing the enter button 122 without changing the content of prescription. In that case, the registration record data indicating whether the case information CI has been registered or not is revised. Furthermore, as shown in FIG. 12, comments are inputted in the comment column 91 for displaying past illness, cause, main symptom, course, etc. Also, remarks are inputted beside the prescribed medicaments in the comment column 92 for prescription, operation, treatment, etc. When all the necessary information and comments are entered in the dialog box 90, a not-shown complete button is pressed. Then the MSI file is revised and memorized in the medical chart database 27 of the HDD 22.

If the registration record data, which is attached to the MSI file that has just been read out from the medical chart database 27, indicates that any case information CI is not registered with respect to the previous prescription, the warning dialog box 70 appears on the monitor 36, requiring the operator to check whether the effects and affections of the previous prescription have been registered, as shown in FIG. 6. When the OK button 71 of the warning dialog box 70 is pressed, the case information registering dialog box 75 appears on the monitor 36, as shown in FIG. 7, so that the doctor inputs data and comments in the respective columns of the dialog box 75. For example, in a case where no side-effect was caused by the prescribed medicaments, such a comment is written in the column 79 that the previous prescription does not adversely affect the patient. Thereafter when the register button 83 is pressed, the CPU 20 sends the case reporting data entered through the dialog box 75 to the data center 13, and also revise the content of the MSI file with the case reporting data. Thereby, the comment written in the column 79 of the dialog box 75 is displayed in the comment column 91 of the dialog box 90. In this way, the electronic medical chart of a patient reflects the data entered as the case information CI about the patient.

When the case reporting data is sent to the data center 13, the data registering section 59 of the data center 13 registers the received case reporting data as new case information CI in the medicament-to-case information database 62. When the new case information CI is registered, the data center 13 sends the registration complete signal back to the client terminal 15, upon which the client terminal 15 adds a record to the registration record data, indicating that the latest case information CI has been registered in the data center 13, and attaches the revised registration record data to the corresponding MSI file. In this way, the data center 13 accumulates the case information CI on a large number of cases as reported by a lot of medical facilities through the client terminals 15.

According to the present embodiment, the case information CI is retrieved when it is found that the prescribed medicaments can interact and affect adversely when used in combination, or that they are incompatible. To some combination of medicaments, a lot of cases can be retrieved as case information CI. Then, it is possible to restrict the range for searching the case information CI by adding some information on the patient to the search criteria beside the medicament names obtained from the prescription data. For this purpose, the patient data is attached to the inquiry data beside the prescription data. If, for example, the patient in question took an inspection, such as X-ray radiography or MRI scanning, and information on the patient has already been registered in the data center 13, the patient ID may be attached to the inquiry data. Thereby, the retrieved case information CI fits the patient more precisely. The patient data may be used as it is, or it is possible to change the search criteria appropriately. For example, it is possible to allow some margin around the patient's age when the age is used as one search criterion.

Although the above embodiment has been described with respect to a case where some case information CI is retrieved from the medicament-to-case information database 62, there may be a case where no case information CI relating to the prescribed medicaments is retrieved. In that case, a notice may be displayed on the monitor 36 of the client terminal 15, to notify that there is not any case information CI responding to the inquiry, or it is possible to display some of most frequently retrieved case information CI on the monitor 36.

Although the above described embodiment relates to a case where caution is advised on combined use of a pair of medicaments, there may be those cases where cautions against combined use are given to a plurality of combinations of medicaments. In those cases, it is possible to display a dialog box for choosing one of a plurality of retrieved case information.

For example, when a case information display button of a caution dialog box is pressed, a dialog box 140 as shown in FIG. 16 appears, so that the operator may designate which one of a plurality of retrieved case information is to be displayed. If there are two combinations among the prescribed medicaments, e.g. one is a combination of prednisolone tablets and fenobal-30 mg tablets, and the other is a combination of prednisolone tablets and BBBBBB tablets, both combinations having risk of adverse interaction and side-effect, the operator checks one of two check boxes 141 and 142 for choosing one of these combinations, and presses an enter button 143. Then, case information CI on the chosen combination of medicaments is displayed on a monitor 36. In this embodiment, when the display of the chosen case information is terminated, the dialog box 140 is displayed again, so that the case information CI on the other combination of medicaments may be displayed on the monitor 36. If the operator does not want to display the case information, a cancel button 144 is pressed to put off the dialog box 140.

According to the above embodiments, if the content of prescription is not revised or the content of prescription is revised but some case information CI relating to the revised content has been registered, the dialog box presenting the electronic medical chart is displayed without displaying the case reporting dialog box. But even if the content of prescription is not revised, it is possible to display the warning dialog box for requesting registration of case information on the previous prescription. Thereby, it comes to be possible to report long-term course of the patient who is taking such medicaments that can adversely interact when administrated concomitantly, and register the long-term course of the patient as case information. In this embodiment, previously registered case information relating to the corresponding prescription should be revised appropriately. Furthermore, if the prescription data is revised as the same content, and the case information CI on this content has been registered at the previous consultation, it is possible not to register the case information CI on the same content of prescription. Moreover, when the content of prescription is changed, it is possible to register case information CI on the changed content of prescription after registering the previous content of prescription.

In the above-described embodiment, plural kinds of medicaments are prescribed for one patient, but the present invention is applicable to a case where a single kind of medicament is prescribed. In that case, the patient data and the prescription data are attached to the inquiry data that is sent to the data center. Then the data server of the data center refers to the patient data and the prescription data to check whether the prescribed medicament is adequate to the patient. Thereby, if the patient is allergic to some medicaments or the like, adequacy of the prescribed medicament is checked in this aspect.

Although data of each electronic medical chart is stored as a MSI file in the medical chart database that is provided in the HDD of the client terminal of the individual medical facility in the above-described embodiment, it is alternatively possible to store the data of the electronic medical charts in the data center. In that case, the case information CI may be registered at the respective client terminals, or the case information CI may be automatically produced when the electronic medical chart is stored in the data center. Then, the data server can retrieve the case information CI from the case information database and the stored electronic medical charts as well.

In the above embodiments, hospitals and clinics are referred to as the medical facilities connected through the network to the data center. But pharmacies may of course be included in the medical facilities. Then, the medical network system can serve as an assistant system for pharmacists or dispensers to inform patients of the details of prescribed medicaments.

Although the medical network system of the above embodiment consists of a plurality of medical facilities and a data center, the present invention is not limited to this embodiment, but is applicable to a network system that consists of a plurality of client terminals and a data server, which are installed in a medical facility. The present invention is not limited to a system, but may also be applicable to a case where medical information is read out from a storage device of a client terminal, and is displayed on a monitor.

Thus, the present invention is not to be limited to the above embodiments but, on the contrary, various modifications will be possible without departing from the scope of claims appended hereto.

What is claimed is:

1. A prescription assisting apparatus connected through a network to a plurality of terminals installed in medical facilities, so as to receive inquiries about prescription content from the terminals and send advisory information on the inquired prescription content back to said terminals, said prescription assisting apparatus comprising:
a basic information database storing basic information on medicaments;
an advisory information searching device that checks the inquired prescription content with said basic information to retrieve the advisory information;
a device for receiving case information from said terminals, each of said case information informing of concrete effects of prescribed medicaments reported about a patient who took the prescribed medicaments;
a case information database for registering and accumulating said received case information;
a case information searching device for searching said case information database to retrieve such case information that relate to the inquired prescription content; and
a device for sending the retrieved advisory information accompanied with the related case information back to the terminal from which the inquiry has been sent.

2. A prescription assisting apparatus as recited in claim 1, wherein said basic information include information on interaction between the medicaments, and said advisory information searching device includes a device for checking whether the inquired prescription content is adequate in view of the interaction.

3. A prescription assisting apparatus as recited in claim 2, wherein said information on the interaction include information on incompatibility and cautions about concomitant administration of the medicaments.

4. A prescription assisting apparatus as recited in claim 3, wherein when the retrieved advisory information indicates that the inquired prescription content includes a combination of medicaments that need caution about concomitant administration, said case information searching device searches for such case information that relate to the interaction between these medicaments.

5. A prescription assisting apparatus as recited in claim 1, wherein if the inquiry from the terminal information includes information on attributes of the patient, said case information searching device adds to the attribute information to search criteria to retrieve said case information from a restricted range of said case information database.

6. A prescription assisting method using a network system for receiving inquiries about prescription content from a plurality of terminals installed in medical facilities and sending advisory information on the inquired prescription content back to said terminals, said prescription assisting method comprising steps of:
storing basic information on medicaments in a basic information database;
checking the inquired prescription content with said basic information to retrieve the advisory information;
receiving case information from said terminals, each of said case information informing of concrete effects of prescribed medicaments reported about a patient who took the prescribed medicaments;
registering and accumulating said received case information in a case information database;
searching said case information database for such case information that relate to the inquired prescription content; and
sending the retrieved advisory information accompanied with the related case information back to the terminal from which the inquiry has been sent.

7. A prescription assisting method as recited in claim 6, wherein said basic information include information on interaction between the medicaments, and said prescription assisting method further comprises a step of checking whether the inquired prescription content is adequate in view of the interaction.

8. A prescription assisting method as recited in claim 7, wherein when the retrieved advisory information indicates that the inquired prescription content includes a combination of medicaments that need caution about concomitant administration, such case information is searched for that relate to the interaction between these medicaments.
